(19) United States
(12) Patent Application Publication
(10) Pub. No.: US 2018/0121091 A1
(43) Pub. Date: May 3, 2018

(54) STORAGE APPARATUS AND ITS CONTROL METHOD

(71) Applicant: HITACHI, LTD., Tokyo (JP)

(72) Inventors: Ken TOKORO, Tokyo (JP); Yuta KAJIWARA, Tokyo (JP)

(21) Appl. No.: 15/553,180

(22) PCT Filed: Mar. 31, 2015
(86) PCT No.: PCT/JP2015/060167

§ 371 Date: Aug. 24, 2017

(51) Int. Cl. G06F 3/06

(52) U.S. Cl. CPC G06F 3/061; G06F 3/0644; G06F 3/0659; G06F 3/0689

(57) ABSTRACT

A storage apparatus and its control method capable of effectively preventing degradation of response performance with respect to I/O commands are proposed. Regarding the storage apparatus and its control method, a command processing unit having ownership of a logical device is set to that logical device in advance with respect to each logical device; a plurality of logical units are managed as one group and one logical unit in the group is defined as a logical unit representative of the group; and when according to a format of a command issued from a host system a logical unit targeted by the command is a logical unit other than the logical unit representative of the logical unit in the group, the command is transferred to the command processing unit having the ownership of the logical device associated with the logical unit targeted by the command.

### TECHNICAL FIELD

The present invention relates to a storage apparatus and its control method. Particularly, the invention is suited for application to a storage apparatus for which a processing method with LDEV (Logical Device) ownership applied thereto is adopted as a method for processing I/O (Input/Output) commands and a Conglomerate LUN method is adopted as a method for managing logical units (LU).

### BACKGROUND ART

Recently, response performance required for a storage apparatus has been becoming higher day by day along with the advancement of IT (Information Technology). In order to meet such requirement, recently there have appeared many storage apparatuses equipped with a plurality of processors for processing I/O commands from a host system.

Conventionally, there has been a processing method of using a command device as a method for processing the I/O commands at the above-described storage apparatus (for example, see PTL 1).

With an information processing system to which this processing method is applied, a logical unit which is called a command device is provided, separately from a logical unit from/to which the host system reads/writes data, within the storage apparatus and the host system writes a command to the storage apparatus, as data, to the command device.

Then, at the storage apparatus, a processor capable of then executing that command, from among a plurality of processors, reads the command, which has been written to the command device, from the command device and executes the command.

### CITATION LIST

### Patent Literature

PTL 1: Japanese Patent Application Laid-Open (Kokai) Publication No. 2002-209149

### SUMMARY OF THE INVENTION

### Problems to be Solved by the Invention

Meanwhile, a processing method to which LDEV (Logical Device) ownership described later is applied has been recently proposed as an I/O command processing method and methods such as a conglomerate LUN method described later have been proposed as logical unit management methods.

A storage apparatus that adopts both the I/O command processing method, to which the LDEV ownership is applied, and the conglomerate LUN method has problems of unnecessary transfer of I/O commands within the storage apparatus as described later and degradation of the response performance with respect to the I/O commands.

The present invention was devised in consideration of the above-described circumstances and aims at proposing a storage apparatus and its control method capable of effectively preventing degradation of the response performance with respect to I/O commands.

### Means to Solve the Problems

In order to solve the above-described problems, provided according to an embodiment of the present invention is a storage apparatus including a plurality of storage devices for managing storage areas provided by the respective storage devices as one pool, associating logical devices, which are cut out from part of the pool, with logical units, and providing the logical units as storage areas to a host system, wherein the storage apparatus includes: a channel control unit that transmits and receives a command and data to and from the host system; and a plurality of command processing units, each of which processes the command from the host system; wherein each of the command processing units having ownership of a logical device is set to that logical device in advance with respect to each logical device and the command, which is targeted at the logical unit associated with the logical device, from the host system is executed by the command processing unit having the ownership of the logical unit; wherein a plurality of the logical units are managed as one group and one logical unit in the group is defined as a logical unit representative of the group; and wherein a format of the command targeted at the logical unit representative of the group is different from a format of the command targeted at the logical unit other than the above-mentioned logical unit in the group; and wherein the channel control unit analyzes the format of the command issued from the host system; and wherein when on the basis of a result of the analysis the logical unit targeted by the command is the logical unit other than the logical unit representative of the logical unit in the group, the channel control unit transfers the relevant command to the command processing unit having the ownership of the logical device associated with the logical unit targeted by the command.

Furthermore, provided according to an embodiment of the present invention is a control method for a storage apparatus including a plurality of storage devices for managing storage areas provided by the respective storage devices as one pool, associating logical devices, which are cut out from part of the pool, with logical units, and providing the logical units as storage areas to a host system, wherein the storage apparatus includes: a channel control unit that transmits and receives a command and data to and from the host system; and a plurality of command processing units, each of which processes the command from the host system, wherein each of the command processing units having ownership of a logical device is set to that logical device in advance with respect to each logical device and the command, which is targeted at the logical unit associated with the logical device, from the host system is executed by the command processing unit having the ownership of the logical unit; wherein a plurality of the logical units are managed as one group and one logical unit in the group is defined as a logical unit representative of the group; and wherein a format of the command targeted at the logical unit representative of the group is different from a format of the command targeted at the logical unit other than the above-mentioned logical unit in the group; and wherein the control method includes: a first step executed by the channel control unit analyzing the format of the command issued from the host system; and a second step executed, when on the basis of a result of the analysis the logical unit targeted by the command is the logical unit other than the logical unit representative of the logical unit in the group, by the channel control unit transferring the relevant command to the command processing unit having the ownership of the logical device associated with the logical unit targeted by the command.

### Advantageous Effects of the Invention

A storage apparatus and its control method capable of effectively preventing degradation of the response performance with respect to I/O commands can be implemented according to an embodiment of the present invention.

### BRIEF DESCRIPTION OF DRAWINGS

FIG. 1 is a block diagram illustrating an overall configuration of an information processing system according to this embodiment;

FIG. 2 is a conceptual diagram for explaining a logical structure and LDEV ownership of first and second storage apparatuses;

FIG. 3 is a conceptual diagram illustrating the structure of a host target MPPK search table;

FIG. 4 is a conceptual diagram illustrating the structure of an inter-storage-apparatus I/O command MPPK search table;

FIG. 5 is a conceptual diagram for explaining a processing flow regarding the LDEV ownership;

FIG. 6 is a conceptual diagram for explaining a processing flow regarding the LDEV ownership;

FIG. 7 is a conceptual diagram for explaining a processing flow regarding the LDEV ownership;

FIG. 8 is a conceptual diagram for explaining a logical unit conglomerate;

FIG. 9 is a conceptual diagram for explaining the logical unit conglomerate;

FIG. 10A is a conceptual diagram illustrating the structure of an ALU-SLU relation table and FIG. 10B is a conceptual diagram illustrating the structure of an ALU-LDEV relation table;

FIG. 11 is a conceptual diagram illustrating a LUN format of an I/O command which designates, for example, an ALU as an I/O target;

FIG. 12 is a conceptual diagram illustrating a LUN format of an I/O command which designates, for example, an SLU as an I/O target;

FIG. 13 is a flowchart illustrating a processing sequence for I/O command transfer processing executed by a local router;

FIG. 14 is a conceptual diagram for explaining I/O processing when I/O commands to an SLU compete against each other;

FIG. 15 is a conceptual diagram illustrating the structure of a priority management table;

FIG. 16 is a conceptual diagram for explaining a queue for each ALU; and

FIG. 17 is a conceptual diagram for explaining a processing method when I/O commands to an SLU compete against each other.

### DESCRIPTION OF EMBODIMENTS

This embodiment will be described below in detail with reference to the drawings.

### (1) Configuration of Information Processing System According to this Embodiment

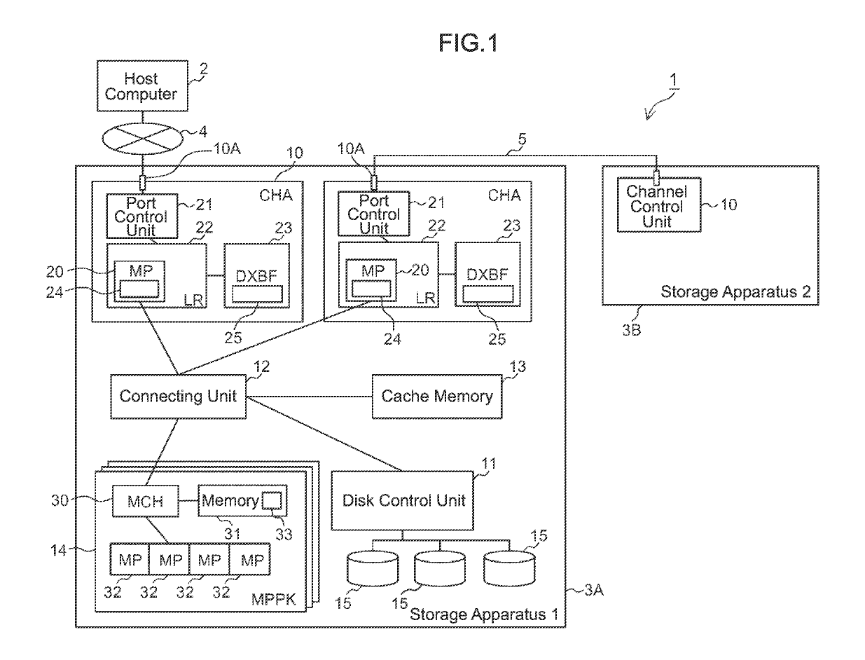

Referring to FIG. 1, reference numeral 1 generally represents an information processing system according to this embodiment. This information processing system 1 is configured by including a host computer 2 and first and second storage apparatuses 3A, 3B.

The host computer 2 is a computer system equipped with information processing resources such as a CPU (Central Processing Unit) and a memory and is configured of, for example, a personal computer, a workstation, or a mainframe. The host computer 2 is connected to the first storage apparatus 3A via a network 4 and reads/writes desired data from/to the first storage apparatus 3A by sending I/O commands such as read commands and write commands to the first storage apparatus 3A.

Each of the first and second storage apparatuses 3A, 3B is configured by including one or more channel control units 10, one or more disk control units 11, a connecting unit 12, a cache memory 13, a plurality of microprocessor packages 14, and one or more storage devices 15, each of which is connected to each disk control unit 11.

The channel control unit 10: is hardware functioning as an interface upon communications with the host computer 2 and the other storage apparatus (the second or first storage apparatus 3B, 3A) which is not its local storage apparatus; and includes one or more ports 10A, a microprocessor 20, a port control unit 21, a local router 22, and a buffer memory 23.

Each port 10A is assigned a unique address, such as an IP (Internet Protocol) address or a WWN (World Wide Network). The first and second storage apparatuses 3A, 3B are accessed by designating the address of a specific port 10A permitted by an access source.

The microprocessor 20 is hardware that has a function controlling the operation of the entire channel control unit 10; and various processing of the entire channel control unit 10 is conducted by executing a control program 24. Moreover, the port control unit 21 is an interface which performs protocol control when communicating with the host computer 2.

The local router 22 is a virtual router embodied by execution of the control program 24 by the microprocessor 20 and has an I/O command transfer function that transfers a received I/O command to an appropriate microprocessor package 14. Incidentally, the details of the “appropriate microprocessor package” will be explained later. Furthermore, the buffer memory 23 is used as a data buffer upon data transfer between the channel control unit 10 and the host computer 2. This buffer memory 23 also stores various control information 25 explained later.

The disk control unit 11 is hardware that functions as an interface for the storage devices 15. The disk control unit 11 accesses the relevant storage device 15 on the basis of an I/O command which is issued from the host computer via the channel control unit 10, and reads/writes data from/to a storage area, which is designated by the I/O command, in that storage device 15.

The connecting unit 12 is configured of, for example, an ultra-high-speed crossbar switch; and all the channel control units 10, the disk control unit 11, the cache memory 13, and the microprocessor packages 14 are connected to the connecting unit. Data and various commands are transmitted and received, via this connecting unit 12, between these channel control units 10, the disk control unit 11, the cache memory 13, and the microprocessor packages 14.

Each cache memory 13 is configured of one or more semiconductor memory elements (for example, DRAM [Dynamic Random Access Memory]). The cache memory 13 temporarily stores data which is exchanged between the channel control unit 10 and the disk control unit 11 on the basis of I/O commands from the host computer 2 (that is, data which is read from, or written to, the storage device 15).

The microprocessor package 14 is configured by including a memory controller hub 30, a local memory 31, and a plurality of microprocessors 32. The memory controller hub 30 is a hub that connects the plurality of microprocessors 32 to the local memory 31. Furthermore, the local memory 31 is used to, for example, retain a control program (microprogram) 33.

The microprocessor 32 is hardware having a function that controls the operation of the entire first or second storage apparatus 3A, 3B. The microprocessor 32 reads the control program (microprogram) 33 from the local memory 31 via the memory controller hub 30 and processes an I/O command, which is issued from the host system (the host computer 2 in the case of the first storage apparatus 3A or the first storage apparatus 3A in the case of the second storage apparatus 3B) via the channel control unit 10 and the connecting unit 12, in accordance with the relevant control program 33. Incidentally, the processing of the I/O command is executed by a microprocessor 32 having sufficient capacity capable of processing the I/O command, from among the plurality of microprocessors 32.

The storage device 15 is configured of, for example, expensive disks such as SCSI (Small Computer System Interface) disks and inexpensive disks such as SATA (Serial AT Attachment) disks or optical disks.

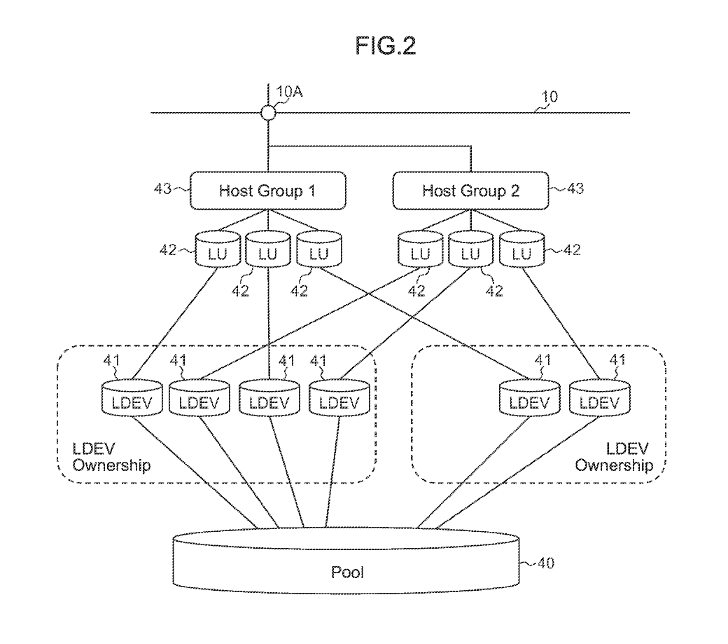

Referring to FIG. 2, storage areas provided respectively by one or more storage devices 15 are managed as one storage area called a pool 40 and partial areas in the pool 40 are cut out and managed as logical devices (hereinafter referred to as LDEVs [Logical Devices]) 41. Then, each of these LDEVs 41 is associated with a logical unit 42 having the same capacity as that of the relevant LDEV 41 and these logical units 42 are provided as storage areas to the host computer 2. Incidentally, a plurality of logical units 42 allocated to the same host computer 2 are managed as a host group 43.

Each logical unit 42 is assigned its unique identifier (LUN). Then, this LUN is combined with a number which is assigned to each block of specified size in the logical unit 42 (hereinafter referred to as the logical block) and is unique to the assigned logical block (LBA: Logical Block Address) to form an address and data is read from, and written to, each logical unit 42 by designating the relevant address via an I/O command. Incidentally, reading/writing of data from/to the logical unit 42 is practically performed with respect to a storage area associated with the address designed by the I/O command within the LDEV 41 associated with the relevant logical unit 42.

In addition to the above-described configuration, the first and second storage apparatuses 3A, 3B according to this embodiment are equipped with a replication function that replicates data, which is written by the host computer 2 to a logical unit 42 in the first storage apparatus 3A, to a logical unit 42 in the second storage apparatus 3B which is set to constitute a pair with the above-mentioned logical unit 42.

Accordingly, in a case of this information processing system 1, a specified channel control unit 10 of the first storage apparatus 3A and a specified channel control unit 10 of the second storage apparatus 3B are connected via a channel 5 such as a cable or a network.

Then, when data is written by the host computer 2 to a logical unit 42 and the logical unit 42 is set to constitute a pair with any one of logical units 42 in the second storage apparatus 3B, the first storage apparatus 3A transfers the data, together with the I/O command, to the second storage apparatus 3B via the channel 5 synchronously or asynchronously with the data writing.

Furthermore, the second storage apparatus 3B which has received this data and the I/O command writes this data to the logical unit 42 in its own storage apparatus, which is set to constitute the pair with the logical unit 42 in the first storage apparatus 3A where the data is written, according to this I/O command.

### (2) LDEV Ownership

(2-1) Outlines of LDEV Ownership

Next, the LDEV ownership will be explained. In a case of this embodiment, a microprocessor package 14 having the authority to process an I/O command to an LDEV 41 is set to that LDEV 41 in advance with respect to each LDEV 41 in the first and second storage apparatuses 3A, 3B. In this description, this authority will be hereinafter referred to as the LDEV ownership of the relevant LDEV. This LDEV ownership is set to any one of microprocessor packages 14 in accordance with an instruction from outside when creating an LDEV 41, or automatically when there is no instruction from outside.

The LDEV ownership can be transferred to another microprocessor package 14 without stopping the first or second storage apparatus 3A, 3B. Therefore, load distribution among the microprocessor packages 14 can be performed by transferring the LDEV ownership as appropriate by checking the status of I/O accesses to LDEVs 41 and monitoring information such as an operating ratio of each processor 32 in the microprocessor packages 14.

Furthermore, when a microprocessor package 14 is locked out due to a failure or other reasons, the LDEV ownership of all LDEVs which the microprocessor package 14 has is transferred to another microprocessor package 14 and I/O processing on the relevant LDEV 41 is continuously executed by the microprocessor package 14 to which the LDEV ownership has been transferred.

(2-2) Functions of Local Router Regarding LDEV Ownership

The local router 22 (FIG. 1) installed in the channel control unit for the first and second storage apparatuses 3A, 3B has an I/O command transfer function that transfers a received I/O command to an appropriate microprocessor package 14 as described above.

This I/O command transfer function can be divided into: a first I/O command transfer function that transfers an I/O command from the host computer 2 to the appropriate microprocessor package 14 (hereinafter referred to as the host I/O command transfer function); and, when replication of data is performed between the first and second storage apparatuses 3A, 3B, a second I/O command transfer function that transfers an I/O command to the first storage apparatus 3A which is a replication source to the appropriate microprocessor package 14 in the second storage apparatus 3B which is a replication destination (hereinafter referred to as the inter-storage-apparatus I/O command transfer function).

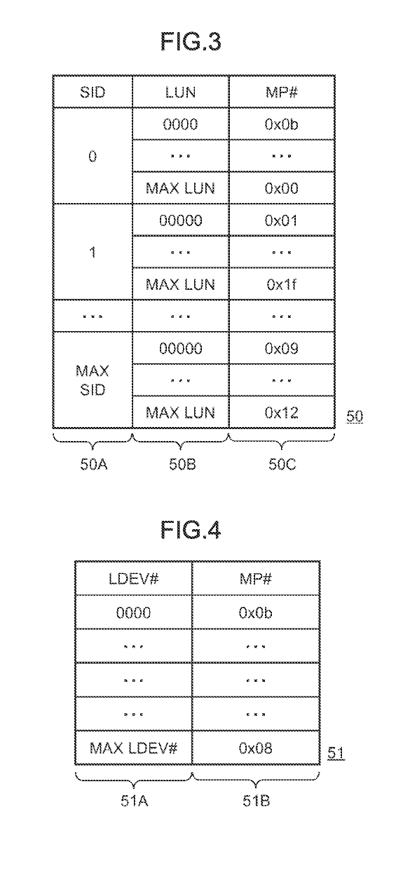

Then, the local router 22 creates and manages a host target microprocessor package search table (hereinafter referred to as the host target MPPK search table) 50 as illustrated in FIG. 3 as associated with each port 10A (FIG. 1) of the channel control unit 10 (FIG. 1) as a means for implementing the above-mentioned host I/O command transfer function.

This host target MPPK search table 50 constitutes part of the aforementioned control information 25 (FIG. 1) stored in the buffer memory 23 (FIG. 1) for the channel control unit 10 and is used to manage the correspondence relationship between a source ID (SID) designated by the host system in accordance with the SCSI standards, each of logical units 42 constituting a group managed by that source ID, and a microprocessor package 14 having the LDEV ownership of each LDEV 41 associated with each of these logical units 42.

Practically, the host target MPPK search table 50 is configured by including an SID column 50A, a LUN column 50B, and a top processor number column 50C as illustrated in FIG. 3. Then, the SID column 50A stores the source ID and the LUN column 50B stores the LUN of each logical unit 42 constituting the corresponding group. Furthermore, the top processor number column 50C stores, among microprocessors 32 (FIG. 1) in the microprocessor package 14 having the LDEV ownership of the LDEV 41 associated with the relevant logical unit 42, a processor number of a microprocessor 32 whose identification number (hereinafter referred to as the processor number) is the smallest (hereinafter referred to as the top microprocessor).

Then, when the local router 22 receives an I/O command from the host computer 2, it acquires the source ID and the LUN of the relevant logical unit 42 from that I/O command and searches the host target MPPK search table 50 for the processor number of the top microprocessor 32 of the microprocessor package 14 having the LDEV ownership of the logical unit 42 by using a combination of the acquired source ID and LUN as a key. Moreover, the local router 22 searches for a microprocessor package 14 corresponding to the top processor number detected by the above search and then transfers the I/O command to that microprocessor package 14.

Meanwhile, the local router 22 creates and manages an inter-storage-apparatus I/O command microprocessor package search table (hereinafter referred to as the inter-storage-apparatus I/O command MPPK search table) 51 as illustrated in FIG. 4 as a means for implementing the aforementioned inter-storage-apparatus I/O command transfer function.

This inter-storage-apparatus I/O command MPPK search table 51 constitutes part of the aforementioned control information 25 (FIG. 1) stored in the buffer memory 23 (FIG. 1) for the channel control unit 10 (FIG. 1) and is used to manage the LDEV ownership of each LDEV 41 (FIG. 2) in its own storage apparatus.

Practically, the inter-storage-apparatus I/O command MPPK search table 51 is configured by including an LDEV number column 51A and a top processor number column 51B as illustrated in FIG. 4. Then, the LDEV number column 51A stores the LDEV number of each LDEV 41 defined in its own storage apparatus and the top processor number column 51B stores the processor number of the top microprocessor 32 of the microprocessor package 14 having the LDEV ownership of the relevant LDEV 41.

Under this circumstance upon replication between the storage apparatuses, I/O commands which are transferred between the storage apparatus on a primary side and the storage apparatus on a secondary side are sometimes exchanged in a vendor unique format. In this case, regarding an I/O command from the host computer 2, a logical unit 42 which is an I/O target is designated by using its LUN and an LDEV to be accessed is specified by converting the LUN to the LDEV number at the storage apparatus which has received this I/O command; however, when exchanging an I/O command between the storage apparatuses, the LDEV number of the LDEV associated with the logical unit which is the I/O target is directly transmitted from the primary storage apparatus to the secondary storage apparatus.

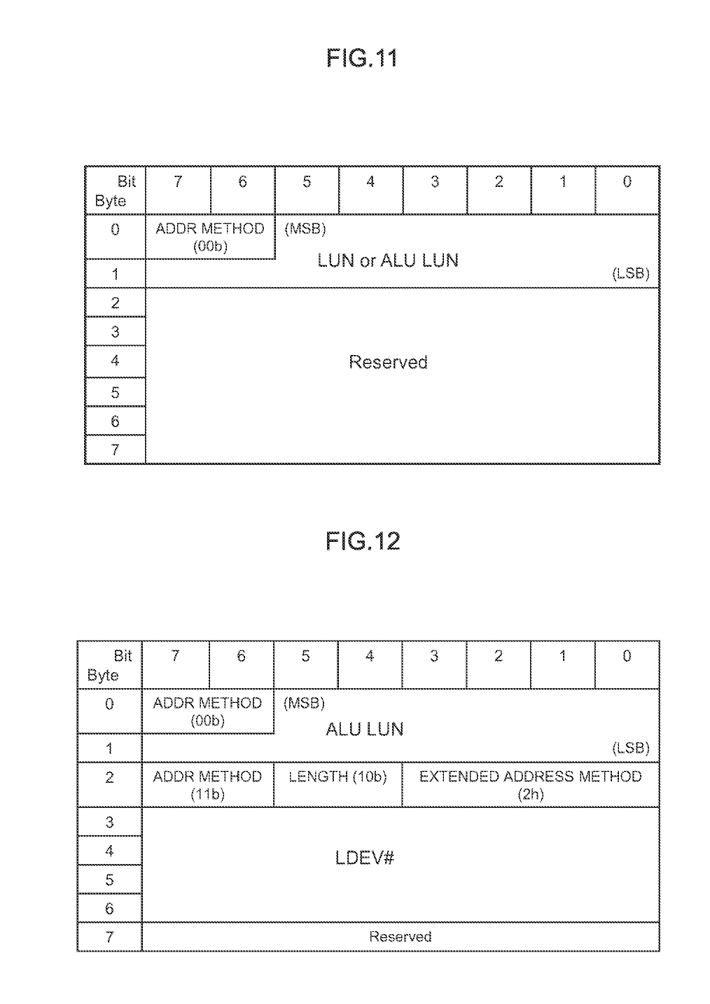

Also in this embodiment regarding an I/O command transferred between the first and second storage apparatuses 3A, 3B, a vendor unique LUN format is applied which stores the LDEV number of an LDEV 41 associated with the relevant logical unit, instead of the LUN of the logical unit which is the I/O target, in a field of Byte 0, Bit 5 to Byte 1, Bit 0 in the LUN format of an SCSI command described later with reference to FIG. 11.

Then, the second storage apparatus 3B which has acquired an I/O command from the first storage apparatus 3A acquires the LDEV number of a target LDEV 41 from the received I/O command and searches the inter-storage-apparatus I/O command MPPK search table 51 for the processor number of the top microprocessor 32 of the microprocessor package 14 having the LDEV ownership of that LDEV 41 by using the acquired LDEV number as a key. Furthermore, the second storage apparatus 3B searches for a microprocessor package 14 associated with the top processor number detected by the search and transfers the I/O command to that microprocessor package 14.

(2-3) Processing Flow Regarding LDEV Ownership

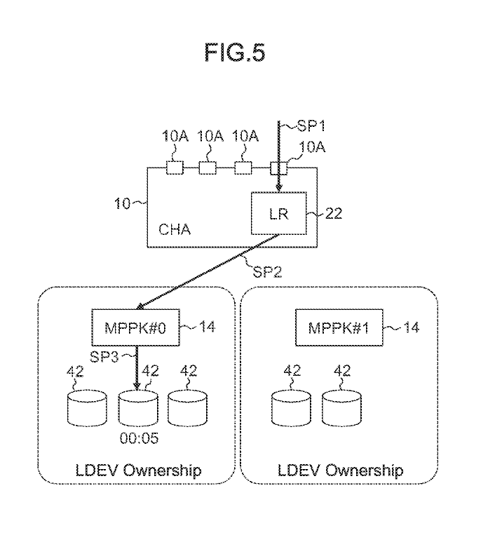

FIG. 5 illustrates a series of I/O processing flow executed by the first or second storage apparatus 3A, 3B which has received an I/O command in relation to the LDEV ownership.

When the channel control unit 10 for the first or second storage apparatus 3A, 3B receives an I/O command from a host system (the host computer 2 in the case of the first storage apparatus 3A or the first storage apparatus 3A in the case of the second storage apparatus 3B) (SP1), it firstly has the local router 22 analyze the received I/O command and identifies a logical unit 42 which is an I/O target.

Then, the local router 22 identifies the microprocessor package 14 having the LDEV ownership of the LDEV 41 (FIG. 2) associated with the identified logical unit 42 by using the host target MPPK search table 50 or the inter-storage-apparatus I/O command MPPK search table 51 as mentioned above and transfers the I/O command to the identified microprocessor package 14 (SP2).

Accordingly, the I/O command is processed by the microprocessor package 14 which has received this transferred I/O command (SP3).

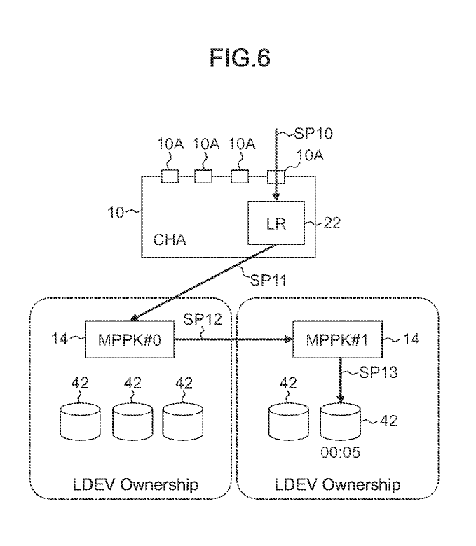

Meanwhile, FIG. 6 illustrates a processing flow when immediately after the I/O command is transferred to the microprocessor package 14, the LDEV ownership of the LDEV 41 associated with the logical unit 42 which is the I/O target of the relevant I/O command is transferred to another microprocessor package 14.

In this case, a flow of processing until the channel control unit 10 which has received the I/O command from the host system transfers the I/O command to the microprocessor package 14 which is the I/O target (SP10, SP11) is the same as the processing flow in the case of FIG. 5.

However, in this case, the microprocessor package 14 which has received the transferred I/O command does not have the LDEV ownership of the I/O target LDEV 41 any longer, so that the I/O command is transferred to a microprocessor package 14 to which the relevant LDEV ownership is transferred (SP12).

Accordingly, the I/O command is processed by the microprocessor package 14 which has received the transferred I/O command (SP13).

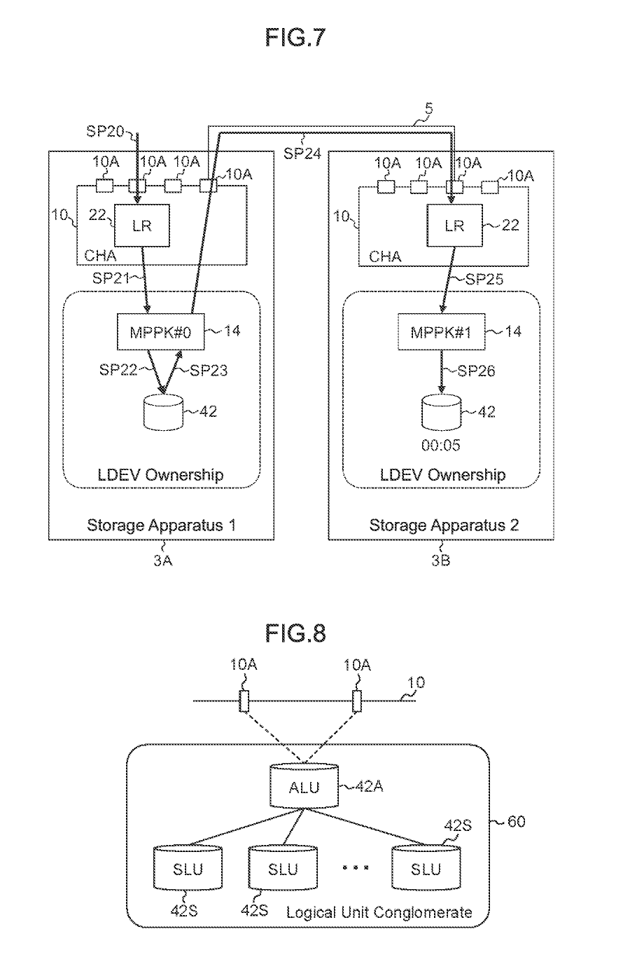

Meanwhile, FIG. 7 illustrates a flow of processing when data replication is executed between the first and second storage apparatuses 3A, 3B.

In this case, a flow of processing until the channel control unit 10 for the first storage apparatus 3A which has received the I/O command from the host computer 2 transfers the I/O command to the microprocessor package 14 which is the I/O target (SP20, SP21) is the same as the processing flow in the case of FIG. 5.

However, in this case, the microprocessor package 14 to which the I/O command from the host computer 2 has been transferred writes data to the logical unit 42 in accordance with the I/O command (SP22) and then transfers the I/O command and the data via the channel control unit 10 and the channel 5 (FIG. 1) to the second storage apparatus 3B (SP23, SP24).

Then, at the second storage apparatus 3B which has received this I/O command and the data, the I/O command is transferred to and processed by a microprocessor package 14 having the LDEV ownership of the LDEV 41 associated with the logical unit 42 designated as the I/O target by the I/O command (SP25, SP26) in the same manner as explained with reference to FIG. 5.

### (3) Logical Unit Conglomerate

(3-1) Outlines of Conglomerate LUN Method

Next, a conglomerate LUN method will be explained. The conglomerate LUN method is a method for management logical units 42, which is proposed in 4r36h of SPC (SCSI Primary Commands).

According to the conglomerate LUN method as illustrated in FIG. 8, a plurality of logical units 42 are formed into a group called a logical unit conglomerate; one logical unit 42 in the logical unit conglomerate 60 is defined as a logical unit 42 representative of the logical unit conglomerate 60 (hereinafter referred to as ALU [Administrative Logical Unit] 42A); and other logical units 42 in that group are defined as logical units 42 under control of the ALU 42A (hereinafter referred to as SLUs (Subsidiary Logical Units) 42S) and are related to the ALU 42A in the logical unit conglomerate 60.

In this case, a path definition of the ALU 42A is performed in the same manner as a normal logical unit 42, so that the host system recognizes the ALU 42A as an SCSI device and executes the conglomerate LUN method according to an I/O command, which is targeted at the ALU 42A belonging to the same logical unit conglomerate 60 as SLUs 42S under its control, in a LUN format described later with reference to FIG. 12.

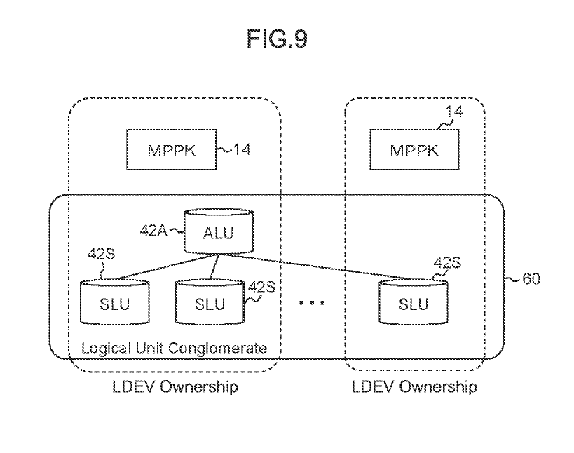

Furthermore, the LDEV ownership can be set independently to each of logical units 42 (the ALU 42A and the SLUs 42S) which constitute the logical unit conglomerate 60. Therefore, for example, as illustrated in FIG. 9, it is possible to set the LDEV ownership of a certain microprocessor package 14 to some of the logical units 42 constituting the same logical unit conglomerate 60 and set the LDEV ownership of another microprocessor package 14 to the remaining logical unit 42.

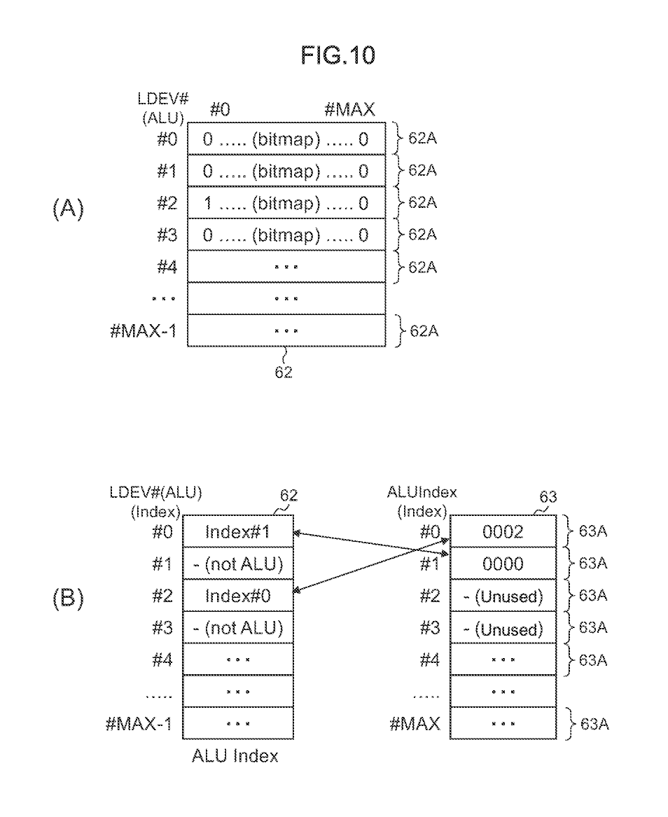

The correspondence relationship between ALUs 42A and SLUs 42S is managed by using an ALU-SLU relation table 62 as illustrated in FIG. 10A. This ALU-SLU relation table 62 includes as many ALU index fields 62A as the number of SLUs which can be set within the system. Then, each ALU index field 62A is related to the LDEV number of an LDEV 41 which is associated with any one of the SLUs 42S.

Furthermore, each ALU index field 62A stores a bitmap having the same bit count as the number of ALUs 42A which can be set within the system. Then, regarding these bitmaps, a bit corresponding to an ALU 42A of a logical unit conglomerate 60 to which an SLU 42S corresponding to the relevant ALU index field 62A belongs is set to “1” and other bits are set to “0.” Incidentally, in the following explanation, the leftmost bit number of the bitmap is set as “0” and the number of bits from the above-mentioned bit to a bit to which “1” is set in the bitmap will be referred to as the index number of the ALU 42A corresponding to that bitmap.

The index number of an ALU 42A is assigned to the ALU 42A as a matter of convenience and is different from the LDEV number of the LDEV 41 which is associated with that ALU 42A. Accordingly, the correspondence relationship between the index number of an ALU 42A and the LDEV number of an LDEV 41 which is associated with that ALU 42A is managed by using an ALU-LDEV relation table 63 illustrated in FIG. 10B.

This ALU-LDEV relation table 63 includes as many LDEV number fields 63A as the number of ALUs which can be set within the system. Then, each LDEV number field 63A is related to the index number of any one of ALUs 42A. Moreover, each LDEV number field 63A stores the LDEV number of an LDEV 41 associated with an ALU 42A of the corresponding index number.

Accordingly, for example, in the case of examples of FIGS. 10A and 10B, for example, it is shown that the index number of an ALU 42A of a logical unit conglomerate 60 to which an SLU 42S associated with an LDEV 41 with the LDEV number “2” is “1” and the LDEV number of an LDEV 41 associated with that ALU 42A is “0000.”

Incidentally, in this embodiment, the ALU-SLU relation table 62 and the ALU-LDEV relation table 63 are stored and retained in the local memory 31 (FIG. 1) for the microprocessor package 14 and are used when the microprocessor 32 processes an I/O command.

(3-2) Characteristics of this Information Processing System

Now, a case where the above-described conglomerate LUN method is applied as a method for managing logical units 42 in the first and second storage apparatuses 3A, 3B to which the LDEV ownership is set to each LDEV 41 as described above will be examined.

In this case, the host computer 2 can recognize only an ALU 42A as an SCSI device among logical units 42 constituting a logical unit conglomerate 60 as described earlier, so that even when the host computer 2 accesses any one of the ALU 42A and the SLUs 42S which constitute the logical unit conglomerate 60, it will always designate the ALU 42A as an I/O target via an I/O command.

Meanwhile, at the first storage apparatus 3A which has received this I/O command, when the I/O target designated by the I/O command is the ALU 42A of the logical unit conglomerate 60 or a normal logical unit 42 which does not constitute the logical unit conglomerate 60, the I/O command is transferred to a microprocessor package 14 having the LDEV ownership of that ALU 42A or the normal logical unit 42.

Then, the microprocessor package 14 which has received this I/O command analyzes the received I/O command; and when the ALU 42A or the normal logical unit 42 associated with an LDEV 41 whose LDEV ownership it has is the I/O target, the microprocessor package 14 processes the I/O command; and when a logical unit 42 associated with an LDEV 41 whose LDEV ownership another microprocessor package 14 has is the I/O target, the I/O command is transferred to the other microprocessor package 14 and the other microprocessor package 14 processes the I/O command.

However, according to such I/O command processing method, when a microprocessor package 14 having the LDEV ownership of an LDEV 41 associated with the ALU 42A of the logical unit conglomerate 60 is different from a microprocessor package 14 having the LDEV ownership of an LDEV 41 associated with an SLU 42S belonging to that logical unit conglomerate 60 (see FIG. 9), an I/O command targeted at that SLU 42S will be always transferred from the microprocessor package 14 having the LDEV ownership of the ALU 42A to the microprocessor package 14 having the LDEV ownership of the SLU 42S. So, there is a problem of degradation of response performance with respect to the I/O command.

Furthermore, under such circumstances, a data transfer amount inside the first storage apparatus 3A is increased, thereby causing a problem of adverse effects on not only the processing of the relevant I/O command, but also processing of other I/O commands as well as other operations.

So, one of characteristics of this information processing system 1 is an I/O command transfer function of the first and second storage apparatuses 3A, 3B such that: when the channel control unit 10 for the first and second storage apparatuses 3A, 3B receives an I/O command from the host system, the local router 22 (FIG. 1) analyzes the I/O command; and when a logical unit 42 which is an I/O target is an SLU 42S of a logical unit conglomerate 60, the I/O command is directly transferred to a microprocessor package 14 having the LDEV ownership of an LDEV 41 associated with the SLU 42S.

As a means for implementing the above function, this information processing system 1 is designed so that the format of a field to designate the logical unit 42 which is the I/O target (hereinafter referred to as the LUN format) differs between the case where an ALU 42A is the I/O target and the case where an SLU 42S is the I/O target, regarding the I/O command transmitted from the host system to the first or second storage apparatus 3A, 3B; and, therefore, the local router 22 (FIG. 1) for the first storage apparatus 3A or the second storage apparatus 3B can easily determine whether the I/O target of the I/O command is an ALU 42A or an SLU 42S, on the basis of the LUN format of the I/O command.

Practically, in the case of this information processing system 1, a LUN format as illustrated in FIG. 11 is used as the LUN format of an I/O command which designates an ALU 42A (and a normal logical unit 42 which does not constitute a logical unit conglomerate 60) as the I/O target.

This LUN format is the format defined as specifications according to the SCSI standards and a field of Byte 0, Bits 7-6 stores “00b” which is a fixed value as “ADDR METHOD.” Furthermore, a field of Byte 0, Bit 5 to Byte 1, Bit 0 stores the LUN of a logical unit which is the I/O target; and a field of Byte 2-Byte 7 stores “0” as “Reserved.”

On the other hand, in the case of this information processing system 1, a LUN format as illustrated in FIG. 12 is used as the LUN format of an I/O command which designates an SLU 42S as the I/O target.

This LUN format is also a format defined according to the SCSI standards and a field of Bytes 0-1 designates the LUN of an ALU 42A belonging to the same logical unit conglomerate 60 in the format similar to that of the field of Bytes 0-1 in FIG. 12.

Moreover, fields from Byte 2, Bit 7 to Byte 7, Bit 0 in this format are areas for designating an SLU 42S; and a field of Byte 2, Bits 7-6 stores “11 b” which is a fixed value as “ADDR METHOD,” a field of Byte 2, Bits 5-4 stores “10b” which is a fixed value as “LENGTH,” and a field of Byte 2, Bits 3-0 stores “2h” which is a fixed value as “EXTENDED ADDRESS METHOD.”

Furthermore, a field of Bytes 3-6 stores the LDEV number of an LDEV 41 associated with the relevant SLU 42S as identification information for identifying the SLU 42S which is the I/O target. By designating the LDEV number of the SLU 42S in this field, the conventional inter-storage-apparatus I/O command MPPK search table 51 can be used and a microprocessor package 14 to which the I/O command is to be transferred can be easily identified when the local router 22 (FIG. 1) analyzes the LUN format. Also, a field of Byte 7 stores “0” as “Reserved.”

(3-3) Processing by Local Router Regarding I/O Command Transfer Function

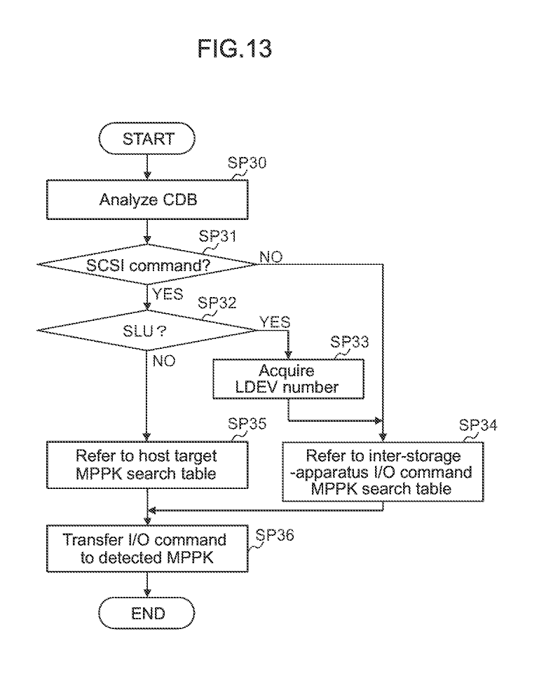

FIG. 13 illustrates specific processing content of the local router 22 (FIG. 1) for the first and second storage apparatuses 3A, 3B regarding the I/O command transfer function according to the aforementioned embodiment. After the local router 22 receives an I/O command from the host system, it transfers the received I/O command to the appropriate microprocessor package 14 in accordance with a processing procedure as illustrated in FIG. 13.

Practically, after receiving the I/O command, the local router 22 starts the I/O command transfer processing as illustrated in FIG. 13, and firstly analyzes a command descriptor block (CDB) of the received I/O command (SP30) and judges whether the I/O command is an SCSI command or not, based on the analysis result (SP31).

Under this circumstance with the information processing system 1 according to this embodiment as described above, the format of the I/O command between the first and second storage apparatuses 3A, 3B is the vendor unique formant and, therefore, obtaining a negative result in this judgment means that the I/O command is an I/O command transmitted from the first storage apparatus 3A to the second storage apparatus 3B and the second storage apparatus 3B has received that I/O command.

Accordingly, the local router 22 then searches the inter-storage-apparatus I/O command MPPK search table 51 (FIG. 4) for the processor number of a top microprocessor 32 (FIG. 1) for a microprocessor package 14 having the LDEV ownership of an LDEV 41 with the relevant LDEV number by using the LDEV number obtained by the analysis in step SP30 as a key (SP34).

Then, the local router 22 transfers the I/O command to the microprocessor package 14 detected by this search (SP36) and then terminates this I/O command transfer processing.

On the other hand, obtaining an affirmative result in the judgment of step SP31 means that the I/O command is an I/O command targeted at any of the following: (A) an ALU 42A in the first storage apparatus 3A; (B) an SLU 42S which belongs to the same logical unit conglomerate 60 as that of the ALU 42A and exists in the first storage apparatus 3A; and (C) a normal logical unit 42 which does not constitute a logical unit conglomerate 60.

Accordingly, the local router 22 then refers to Bytes 2-7 in the LUN format of the I/O command and judges whether the I/O command is an I/O command whose I/O target is an SLU 42S or not (whether the LUN format is not the LUN format in FIG. 11, but is the LUN format in FIG. 12) (SP32).

Then, when the local router 22 obtains a negative result in this judgment, it acquires the LDEV number of an LDEV 41 associated with the I/O target SLU from Bytes 3-6 in the LUN format of the I/O command (SP33).

Furthermore, the local router 22 searches the inter-storage-apparatus I/O command MPPK search table 51 for the processor number of a top microprocessor 32 of a microprocessor package 14 having the LDEV ownership of the logical unit 42 associated with the LDEV 41 with the relevant LDEV number by using the acquired LDEV number as a key (SP34).

Subsequently, the local router 22 transfers the I/O command to the microprocessor package 14 detected by the search (SP36) and then terminates this I/O command transfer processing.

On the other hand, when the local router 22 obtains a negative result in the judgment of step SP32, it acquires the LUN from Bytes 0-1 in the LUN format of that I/O command and searches the host target MPPK search table 50 (FIG. 3) for the processor number of a top microprocessor 32 of a microprocessor package 14 having the ownership of an LDEV 41 associated with the ALU 42A to which the acquired LUN is assigned (SP35).

Subsequently, the local router 22 transfers the I/O command to the microprocessor package 14 detected by the search (SP36) and then terminates this I/O command transfer processing.

### (4) Exclusion Processing when a Plurality of Host Computers Share One SLU

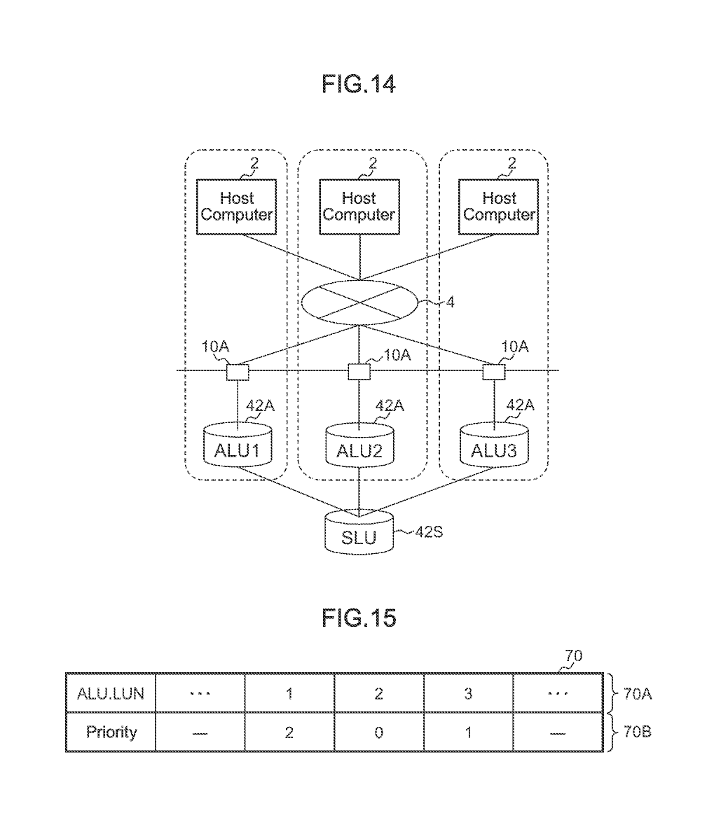

Referring to FIG. 14, when a plurality of ALUs 42A are related to one SLU 42S (that is, that SLU 42S belongs to a plurality of logical unit conglomerates 60) and the respective ALUs 42A are allocated to different host computers 2, these host computers 2 are in the state of sharing that SLU 42S and I/O commands will be issued via a plurality of paths to the SLU 42S. Under such circumstance, a situation where I/O commands from the plurality of host computers 2 to the SLU 42S may compete against each other may occur.

So, this embodiment is designed so that a plurality of ALUs 42A are related to one SLU 42S, priority among these ALUs 42A can be set to these ALUs 42A; and when I/O commands targeted at the SLU 42S as the I/O target are issued simultaneously from the plurality of host computers 2 (when I/O processing is to be executed competitively), the microprocessor 32 (FIG. 1) for the microprocessor package 14 processes these I/O commands in the order according to the priority which is set to the ALUs 42A through which the I/O commands have routed.

As a means for implementing such processing, the local memory 31 (FIG. 1) for each microprocessor package 14 stores a priority management table 70 as illustrated in FIG. 15. The priority management table 70 is a table used to manage the priority of ALUs 42A which are set to the relevant SLU 42S in advance and is prepared for each SLU 42S.

This priority management table 70 includes a LUN field 70A and a priority field 70B; and each LUN field 70A stores the LUN assigned to each ALU 42A existing in the first or second storage apparatus 3A, 3B and the priority field 70B stores a value representing the priority of the relevant ALU 42A that is set to each ALU 42A, to which the relevant SLU 42S is related, with respect to the relevant SLU 42S. Incidentally, in the example of FIG. 15, a smaller value of the priority represents higher priority.

Accordingly, when I/O commands, which are transferred from the channel control unit 10, to the SLU 42S compete against each other, the microprocessor 32 for the microprocessor package 14 refers to the priority management table 70 corresponding to that SLU 42S and prioritizes processing of the I/O command with higher priority of the ALU 42A whose LUN is stored in Bytes 0-2 in the LUN format (FIG. 12) of the I/O command.

This function is equivalent to setting the priority to a plurality of host computers 2 which share the same SLU 42S; and, therefore, the execution of an I/O command from the host computer 2 which executes more important processing can be prioritized by making the first storage apparatus 3A equipped with such function.

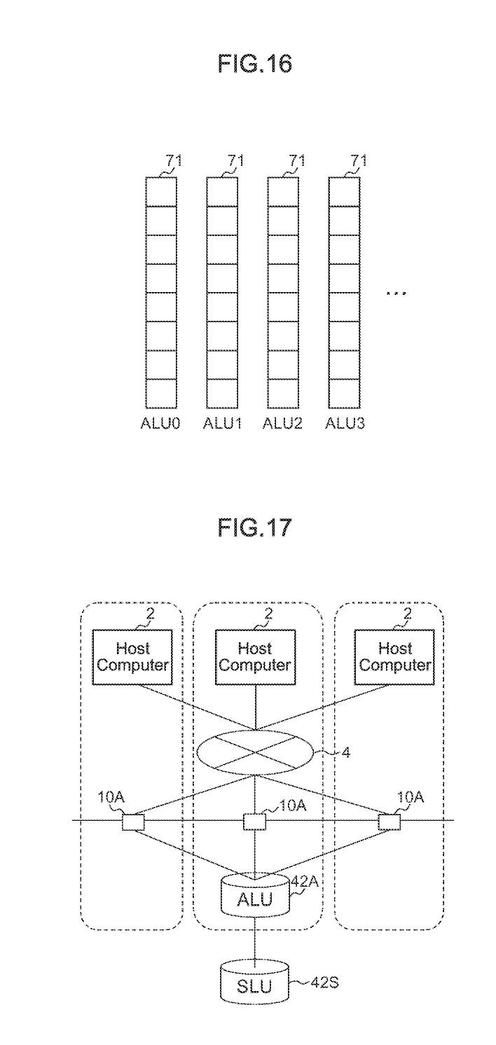

Incidentally, in addition to the above-described configuration, for example, a queue 71 of each ALU 42A associated with the SLU 42S may be prepared for each SLU 42S as illustrated in FIG. 16 in the local memory 31 (FIG. 1) for each microprocessor package 14; and the microprocessor package 14 may store an I/O command, which has been transferred from the channel control unit 10, in a queue 71 of an ALU 42A corresponding to the LUN stored in Bytes 0-2 in the LUN format (FIG. 12) and may process I/O commands stored in these queues 71 repeatedly as many as defined according to, and in the order according to, the priority of the relevant ALU 42A. Incidentally, the phrase “as many as defined according to the priority” means that a larger number of I/O commands which are stored in the queue 71 corresponding to the ALU 42A with higher priority are processed.

For example, referring to FIG. 15, if four ALUs 42A with the LUN ranging from “0” to “3” exist and the priority is set to the ALUs 42A with the descending order of priority in the order of the LUN “2,” “3,” and “1,” for example, three I/O commands stored in the queue 71 corresponding to the ALU 42A which is “ALU2” with the highest priority may be firstly processed; and then two I/O commands stored in the queue 71 corresponding to the ALU 42A which is “ALU3” with the second-highest priority may be processed; and furthermore, one I/O command stored in the queue 71 corresponding to the ALU 42A which is “ALU1” with the lowest priority may be processed; and subsequently, the above-described processing may be repeated.

Even when the above-described method is employed, processing of I/O commands from the host computer 2 which executes more important processing can be prioritized more.

Furthermore, the above-described method can be also applied to the environment where, for example, paths to a plurality of ports 10A are defined for a single ALU 42A as illustrated in FIG. 17. In this case, the priority management table 70 and the queues 71 are prepared not on the SLU 42S basis, but on the ALU 42A basis and the priority among the ports 10A is set to each port 10A.

### (5) Advantageous Effects of this Embodiment

Regarding the information processing system 1 according to this embodiment as described above, when a logical unit 42 targeted by an I/O command from the host system is an SLU 42S, that command is directly transferred to a microprocessor package 14 which has the ownership of an LDEV 41 associated with the relevant logical unit 42, so that it is possible to prevent the occurrence of transfer of the I/O command between microprocessor packages 14 in the first and second storage apparatuses 3A, 3B. Therefore, it is possible to effectively prevent degradation of the response performance with respect to the I/O command, which may be caused by the transfer of the I/O command between the microprocessor packages 14 in the first and second storage apparatuses 3A, 3B.

### (6) Other Embodiments

Incidentally, the aforementioned embodiment has described the case where the present invention is applied to the information processing system 1 configured as illustrated in FIG. 1; however, the present invention is not limited to this example and can be applied to a wide variety of other embodiments of information processing systems.

Furthermore, the aforementioned embodiment has described the case where the microprocessor package 14 as the command processing unit for processing I/O commands from the host system is configured as illustrated in FIG. 1; however, the present invention is not limited to this example and a wide variety of configurations can be applied. In this case, the number of the microprocessors 32 (FIG. 1) which the command processing unit has may be one.

### INDUSTRIAL APPLICABILITY

The present invention can be applied to not only the storage apparatus which adopts the LDEV-ownership-applied processing method as the I/O command processing method and adopts the conglomerate LUN method as the logical unit management method, but also to a wide variety of storage apparatuses which adopt both an I/O command method and a logical unit management method which are similar to those mentioned above.

### REFERENCE SIGNS LIST

1 information processing system
2 host computer
3A, 3B storage apparatuses
10 channel control unit
10A port
14 microprocessor package
15 storage device
20, 32 microprocessors
22 local router
25 control information
41 LDEV
42 logical unit
42A ALU
42B SLU
50 host target MPPK search table
51 inter-storage-apparatus I/O command MPPK search table
60 logical unit conglomerate
62 ALU-SLU relation table
63 ALU-LDEV relation table
70 priority table
71 queue

1. A storage apparatus including a plurality of storage devices for managing storage areas provided by the respective storage devices as one pool, associating logical devices, which are cut out from part of the pool, with logical units, and providing the logical units as storage areas to a host system,
the storage apparatus comprising:
a channel control unit that transmits and receives a command and data to and from the host system; and
a plurality of command processing units, each of which processes the command from the host system,
wherein each of the command processing units having ownership of a logical device is set to that logical device in advance with respect to each logical device and the command, which is targeted at the logical unit associated with the logical device, from the host system is executed by the command processing unit having the ownership of the logical unit;
wherein a plurality of the logical units are managed as one group and one logical unit in the group is defined as a logical unit representative of the group;
wherein a format of the command targeted at the logical unit representative of the group is different from a format of the command targeted at the logical unit other than the above-mentioned logical unit in the group; and
wherein the channel control unit analyzes the format of the command issued from the host system; and
wherein when on the basis of a result of the analysis the logical unit targeted by the command is the logical unit other than the logical unit representative of the logical unit in the group, the channel control unit transfers the relevant command to the command processing unit having the ownership of the logical device associated with the logical unit targeted by the command.

2. The storage apparatus according to claim 1,
wherein regarding the command targeted at the logical unit representative of the group, the targeted logical unit is designated by using an identifier of the relevant logical unit;
wherein regarding the command targeted at the logical unit other than the logical unit representative of the group within the group, an identifier of the logical unit representative of the group, to which the targeted logical unit belongs, and an identifier of the logical device associated with the targeted logical unit are designated;
wherein the channel control unit manages:
a first table that stores a correspondence relationship between the logical unit and the command processing unit having the ownership of the logical device associated with the logical unit; and
a second table that stores a correspondence relationship between the logical device and the command processing unit having the ownership of the logical device;
wherein when the format of the command issued from the host system is the format targeted at the logical unit representative of the group, the channel control unit searches the first table for the command processing unit having the ownership of the logical device associated with the logical unit having the identifier designated by the command and transfers the command to the command processing unit detected by the search; and
wherein the format of the command is the format targeted at the logical unit other than the logical unit representative of the group, the channel control unit searches the second table for the command processing unit having the ownership of the logical device having the identifier designated by the command and transfers the command to the command processing unit detected by the search.

3. The storage apparatus according to claim 2,
wherein the command which designates the identifier of the logical device associated with the targeted logical unit is issued from another storage apparatus constituting the host system; and
wherein when the format of the command issued from the host system is the format of the command from the other storage apparatus, the channel control unit searches the second table for the command processing unit having the ownership of the logical device designated by the command and transfers the command to the command processing unit detected by the search.

4. The storage apparatus according to claim 2,
wherein priority among the logical units is set in advance to each logical unit representative of the group; and
wherein when a plurality of commands targeted at the same logical unit which belongs to a plurality of groups and does not represent any of the groups are transferred from the channel control unit and the plurality of commands compete against each other, the command processing unit processes the commands in an order of the priority which is set to each logical unit representative of each group to which the relevant logical unit belongs.

5. The storage apparatus according to claim 4,
wherein the command processing unit has queues, each of which is associated with the logical unit representative of each group to which the relevant logical unit belongs, with respect to each logical unit other than the logical unit representative of the group and the command processing unit stores the command, which has been transferred from the channel control unit, in the queue according to the identifier of the logical unit as designated by the command; and
wherein the command processing unit repeatedly processes the commands stored in each queue as many as a quantity according to, and in the order of, the priority which is set to each logical unit representative of the group associated with each queue.

6. A control method for a storage apparatus including a plurality of storage devices for managing storage areas provided by the respective storage devices as one pool, associating logical devices, which are cut out from part of the pool, with logical units, and providing the logical units as storage areas to a host system,
the storage apparatus including:
a channel control unit that transmits and receives a command and data to and from the host system; and
a plurality of command processing units, each of which processes the command from the host system,
wherein each of the command processing units having ownership of a logical device is set to that logical device in advance with respect to each logical device and the command, which is targeted at the logical unit associated with the logical device, from the host system is executed by the command processing unit having the ownership of the logical unit;
wherein a plurality of the logical units are managed as one group and one logical unit in the group is defined as a logical unit representative of the group; and
wherein a format of the command targeted at the logical unit representative of the group is different from a format of the command targeted at the logical unit other than the above-mentioned logical unit in the group;
the control method comprising:
a first step executed by the channel control unit analyzing the format of the command issued from the host system; and
a second step executed, when on the basis of a result of the analysis the logical unit targeted by the command is the logical unit other than the logical unit representative of the logical unit in the group, by the channel control unit transferring the relevant command to the command processing unit having the ownership of the logical device associated with the logical unit targeted by the command.

7. The control method for the storage apparatus according to claim 6,
wherein regarding the command targeted at the logical unit representative of the group, the targeted logical unit is designated by using an identifier of the relevant logical unit;
wherein regarding the command targeted at the logical unit other than the logical unit representative of the group within the group, an identifier of the logical unit representative of the group, to which the targeted logical unit belongs, and an identifier of the logical device associated with the targeted logical unit are designated;
wherein the channel control unit manages:
a first table that stores a correspondence relationship between the logical unit and the command processing unit having the ownership of the logical device associated with the logical unit; and
a second table that stores a correspondence relationship between the logical device and the command processing unit having the ownership of the logical device; and
wherein in the second step, when the format of the command issued from the host system is the format targeted at the logical unit representative of the group, the channel control unit searches the first table for the command processing unit having the ownership of the logical device associated with the logical unit having the identifier designated by the command and transfers the command to the command processing unit detected by the search; and
when the format of the command is the format targeted at the logical unit other than the logical unit representative of the group, the channel control unit searches the second table for the command processing unit having the ownership of the logical device having the identifier designated by the command and transfers the command to the command processing unit detected by the search.

8. The control method for the storage apparatus according to claim 7,
wherein the command which designates the identifier of the logical device associated with the targeted logical unit is issued from another storage apparatus constituting the host system; and
wherein in the second step, when the format of the command issued from the host system is the format of the command from the other storage apparatus, the channel control unit searches the second table for the command processing unit having the ownership of the logical device designated by the command and transfers the command to the command processing unit detected by the search.

9. The control method for the storage apparatus according to claim 7,
wherein priority among the logical units is set in advance to each logical unit representative of the group; and
wherein the control method further comprises a third step executed, when a plurality of commands targeted at the same logical unit which belongs to a plurality of groups and does not represent any of the groups are transferred from the channel control unit and the plurality of commands compete against each other, by the command processing unit processing the commands in an order of the priority which is set to each logical unit representative of each group to which the relevant logical unit belongs.

10. The control method for the storage apparatus according to claim 9,
wherein the command processing unit has queues, each of which is associated with the logical unit representative of each group to which the relevant logical unit belongs, with respect to each logical unit other than the logical unit representative of the group and the command processing unit stores the command, which has been transferred from the channel control unit, in the queue according to the identifier of the logical unit as designated by the command; and
wherein in the third step, the command processing unit repeatedly processes the commands stored in each queue as many as a quantity according to, and in the order of, the priority which is set to each logical unit representative of the group associated with each queue.
